(19) United States
(12) Patent Application Publication
(10) Pub. No.: US 2024/0333209 A1
(43) Pub. Date: Oct. 3, 2024

(54) WATER DIVERSION AND GROUNDING SYSTEM

(71) Applicant: Zachary Bailey, Spring, TX (US)

(72) Inventor: Zachary Bailey, Spring, TX (US)

(21) Appl. No.: 18/621,303

(22) Filed: Mar. 29, 2024

Related U.S. Application Data
(60) Provisional application No. 63/455,465, filed on Mar. 29, 2023.

(51) Int. Cl. H02S 30/10; H02S 40/10; H02S 40/30

(52) U.S. Cl. CPC H02S 30/10; H02S 40/10; H02S 40/30

(57) ABSTRACT

The present invention pertains to a water diversion and grounding system for supporting multiple solar panels. The system can have an assembly with a top member, a bottom member, and a compression member, all of the same length. The top and bottom members can be made of aluminum or carbon steel, can be secured to the compression member, made of rubber, using fasteners. The top member has vertical and horizontal extensions, and the bottom member includes a support with vertical and horizontal extensions and a peripheral vertical member. The assembly is designed such that the base, support, and compression member have aligned holes for the insertion of fasteners. When tightened, these fasteners compress the compression member, clamping the solar panel between the base and the support.

### CROSS REFERENCE

This application claims benefit from currently pending U.S. Provisional Application No. 63/455,465 titled “Water Diversion and Grounding System” and having a filing date of Mar. 29, 2023, all of which is incorporated by reference herein.

### FIELD OF THE INVENTION

The present specification relates generally for a water diverting system and more specifically a system for diverting water off of solar panels and grounding the solar panels to a park and shade structure.

### BACKGROUND OF THE INVENTION

It is common in the art for individuals to park under or sit under a shade structure. These structures are typically made from metal roof structures and even more recently solar panels are now being mounted on top of these structures to provide shade and power. Solar panels are a popular method of generating renewable energy. These panels are typically installed on rooftops or other elevated structures to maximize exposure to sunlight. However, these installations often face challenges related to water management and grounding. These panels are mounted to purlins which usually have an upper flat surface that the panels are mounted to and a lower flat portion that mounts to the beam of the structure. The problem with this type of purlin is that it is difficult and time consuming to attach the panels to the purlins and usually require some type of secondary attachment mechanism such as bolts or screws which can damage the solar panel. This type of installation is very time consuming and usually create spacing between the panels allowing water to seep through the cracks and fall to the ground creating unwanted ices or puddles underneath the structure.

Water, especially in the form of rain, can cause damage to the solar panels and the structures supporting them. It can lead to corrosion, structural weakening, and in some cases, electrical short circuits and cause puddles underneath the structure causing dangerous situations for individuals using the parking structure. Therefore, a system that can effectively divert water away from the solar panels and their supporting structures is crucial for the longevity and efficiency of the solar panel installation.

Purlins have attempted to solve this problem, but usually require a secondary attachment point for the solar panels to attach to. Other prior art, such as, U.S. Pat. No. 8,857,133 attempts to fix this issue by forming an opening or channel that allows the panels to slide within the purlin locking the panel between two outwardly extending members. This channel runs the length of the purlin which can cause problems if a panel needs to be replaced. The replacement technique requires all the panels to be removed from the purlin up to the broken panel and then slide back into the panel once the broken panel is replaced. In addition, this type of purlin can create another gap between the panels that can allow the water to seep through and drip on the cars or individuals beneath during storms. Another problem created in areas that snow is that when snow melts and then freezes the puddles created under these panels creates an ice rink under the structure causing dangerous situation for both cars and people walking under the structure. Another problem is that it requires a separate grounding system for the solar panels.

Existing solutions for water diversion and grounding in solar panel installations often involve complex structures and multiple components, which can be difficult and costly to install and maintain. Furthermore, these solutions may not provide adequate water diversion or grounding, leading to reduced efficiency and potential safety risks. Therefore, there is a need for a water diversion and grounding system that is simple to install, effective in diverting water away from the solar panels and their supporting structures and provides reliable grounding. Such a system would enhance the efficiency and safety of solar panel installations, and potentially reduce installation and maintenance costs.

Therefore, it would be highly advantageous to have a water diversion device that couples to the purlin and provides a gutter system that collects and directs the water away from under the structure.

It is another objective of the present invention to provide a new and improved water diversions device that allows the panels or roof structures to be easily installed and removed if a panel is damaged.

It is another objective of the present invention to provide a new and improved water diversions device that allows the solar panels or roof structures to be grounded.

### BRIEF SUMMARY OF THE INVENTION

Accordingly, the present invention can comprise a water diversion and grounding system for supporting a plurality of solar panels. The system comprises an assembly having a length and including a top member, a bottom member, and a compression member. The compression member features a compression top with a compression top width and a compression bottom with a compression bottom width. The top member includes a top base with a top base width, a first top vertical extension extending a first height from the top base, and a first top horizontal member extending from the at least one top vertical extension. The bottom member can include a support with a first bottom vertical extension extending a second height from the support and a first bottom horizontal member extending a first distance from the bottom vertical extension and a first peripheral vertical member extending in the direction of the support from the bottom horizontal member. The system also includes at least one fastener securing the top member and the bottom member to the compression member.

The top member can have at least one second top vertical member extending from the first top horizontal member. The top member can further comprise a second top vertical extension extending the first height from the top base to define a channel, and a second top horizontal member extending from the second top vertical extension. The bottom member can further comprise a second bottom vertical extension extending the second height from the support and a second bottom horizontal member extending the first distance from the second bottom vertical extension and a first peripheral vertical member extending in the direction of the support from the bottom horizontal member to define an inverted channel.

The base, the support, and the compression member can have a plurality of holes extending from one end to the other wherein the holes align with each other allowing the plurality of fasteners to be inserted into the base, support and compression member. The base and the support can compress the compression member and clamp the solar panel between the base and the support when the plurality of fasteners is tightened. The top member and bottom member can be made of aluminum or carbon steel. The compression member may be a rubber material. The length of the top member, bottom member and compression member may be the same length to define the length of the assembly. The length can be about 36 inches. The solar panel can be grounded to the assembly.

This water diversion and grounding system provides a robust and efficient solution for supporting and grounding solar panels, while also facilitating water diversion. The system's design allows for easy assembly and disassembly, and its materials ensure durability and longevity.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for” and will also recite the word “function” (i.e., will state “means for performing the function of . . . , without also reciting in such phrases any structure, material or act in support of the function. Thus, even when the claims recite a “means for performing the function of molding a . . . , step for performing the function of molding a . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is an isometric view of the water diversion and grounding device in accordance to one, or more embodiments;

FIG. 2 is a front view of the water diversion and grounding device in accordance to one, or more embodiments;

FIG. 3 is a top view of the water diversion and grounding device in accordance to one, or more embodiments;

FIG. 4 is a top view of the water diversion and grounding device in accordance to one, or more embodiments; and

FIG. 5 is an isometric view of the water diversion and grounding device in accordance to one, or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

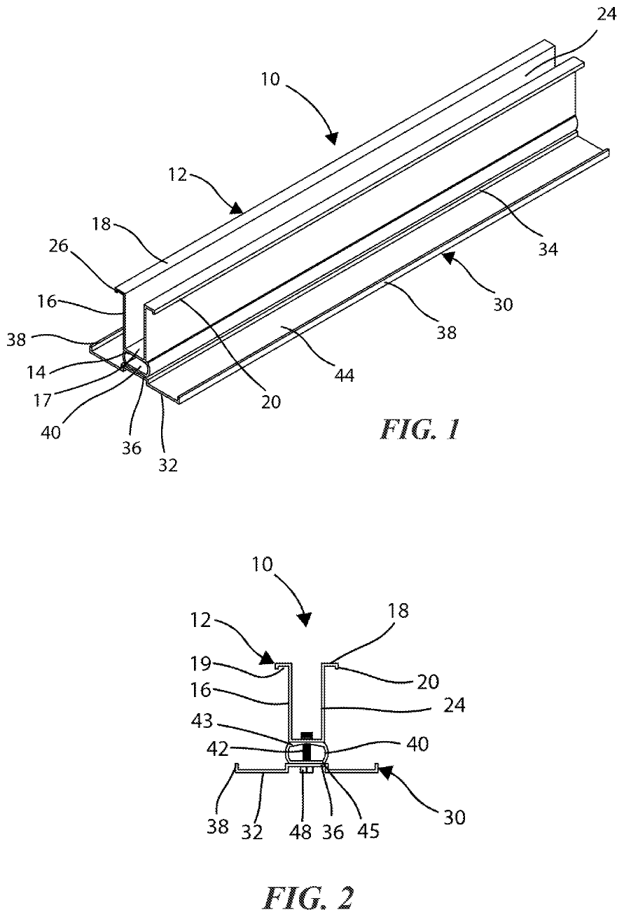

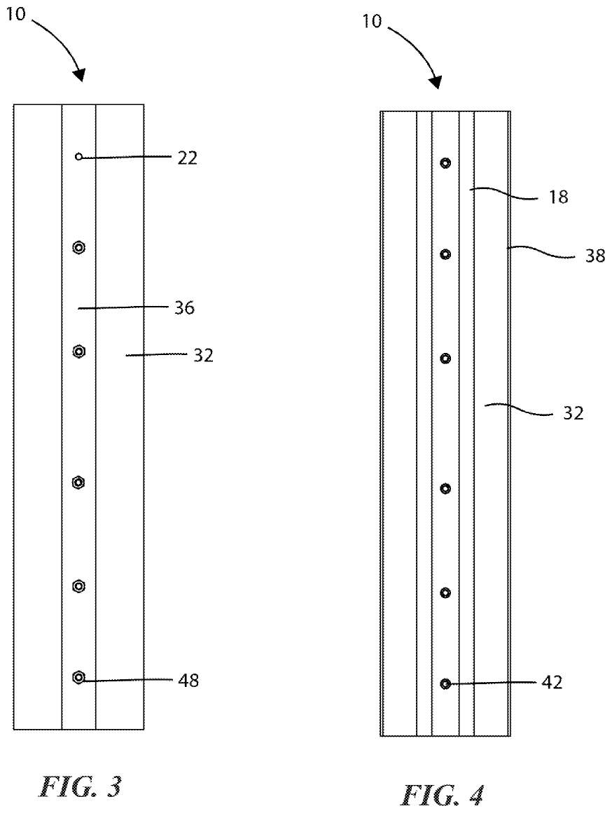

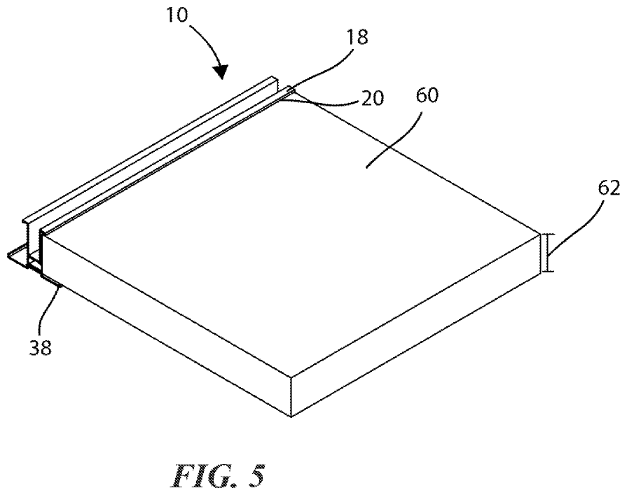

Referring initially to FIGS. 1-4, a water diversion and grounding device for supporting a plurality of solar panels is shown generally at 10. The water diversion device 10 can be support a plurality of solar panels 60, as shown in FIG. 5. The water diversion device 10 can be an assembly having a length and comprising a top member 12, a bottom member 30 and a compression member 40. The compression member 40 can have a compression top 43 having a compression top width and a compression bottom 45 having a compression bottom width. The top member 12 can comprise a top base 14 with a top base width, a first top vertical extension 16 extending a first height from the top base, and a first top horizontal member 18 extending from the at least one top vertical extension. The bottom member 30 can comprise a support 36 with a first bottom vertical extension 34 extending a second height from the support and a first bottom horizontal member 32 extending a first distance from the bottom vertical extension and a first peripheral vertical member 38 extending in the direction of the support from the first bottom horizontal member. At least one fastener 42 securing the top member 12 and the bottom member 30 to the compression member 40.

The top member 12 can extend at a length of such as for example, at least one inch to at least three hundred inches, the top base 14 with the at least one first top vertical member 16 can extend from the top base at a first distance and the at least one first top horizontal member 18 can extend from the first top vertical member. The first distance can be such as for example, between 1 inch to 48 inches and even more preferably 5 inches to 48 inches and even more preferably 10 to 36 inches. The top member 12 can be any suitable shape, but in the preferred embodiment the shape as shown in FIG. 1 can have a thickness such as for example, 0.0151 to 3 inches, and even more preferably 0.0480 inches to 2 inches and more preferably 0.0595 inches to 0.1054. The top member 12 can be formed by such as, for example, cold rolling, extrusion, casting or the like. The top member 12 can have a plurality of holes 22 on the top base 14 that can be evenly or unevenly spaced. The plurality of holes 22 can be size from such as, for example, at least 1/32-inch hole to at least 1-inch hole. The top member 12 can be one piece or multiple pieces coupled together to get a user specified length to hold one or multiple solar panels 60.

The first top horizontal member 18 can have at least one second top vertical member 20 extending from the first top horizontal member. The second top vertical member 20 can be substantially smaller in length than the first top vertical member 16. In the preferred embodiment, the top member 12 can be a top mirrored portion of the first top vertical member 16, first top horizontal member 18, and second top vertical member 20 wherein the two first top vertical members can form a first channel 24 and the first top vertical member and the second top vertical member can form a second channel 44 on each side of the top member. The first top vertical member 16 can extend from the top base 14 at a distance of such as, for example, at least one inch to at least 24 inches, even more preferrable at least 2 inches to 12 inches and even more preferably at least 3 inches to 5 inches.

The bottom member 30 can extend at a length substantially the same as the top member 12 and can be such as for example, at least one inch to at least three hundred inches and even more preferably two inches to 150 inches and even more preferably 144 inches. The bottom member can have a support 36 with at least one first bottom vertical member 34 extending at a first distance from the support and at least one bottom horizontal member 32 extending from the bottom vertical member at a second distance wherein the distance can be such as, for example, at such as, for example, at least one inch to at least 48 inches, even more preferrable at least 2 inches to 36 inches and even more preferably at least 6 inches to 12 inches. The at least one first peripheral vertical member 38 can extend from the bottom horizontal member 32. A compression member 40 can be coupled between the top member 12 and the bottom member 30 with at least one fastener 42.

The bottom member 30 can have a bottom mirrored portion wherein the at least one first bottom vertical member 34 can extend at a distance, which can be such as, for example, at least one inch to at least 48 inches, even more preferrable at least 2 inches to 36 inches and even more preferably at least 6 inches to 12 inches, from the support and at least one bottom horizontal member 32 can extend from the bottom vertical member at a distance which can be such as, for example, at least one inch to at least thirty-six inches, and at least one second bottom vertical member 38 extending from the bottom vertical member creates a second channel 44.

The top member 12, bottom member 30, and a compression member 40 can have a plurality of holes 22 extending from one end to the other either evenly spaced or unevenly spaced wherein the holes on the top member, bottom member, and compression member can align with each other allowing the plurality of fasteners to be inserted into the base, support and compression member. The at least one fastener 42 can be threaded into such as, for example, directly into the top member 12, directly into the bottom member 30 or by a nut. In embodiments, when the fasteners are tightened down the fastener can compress the compression member 40 and the second top vertical member 20 and the second bottom vertical member 38 can apply a force onto the solar panels capturing the solar panels substantially near the ends of the solar panels.

The top member 12 and bottom member 30 can made from be such as, for example, carbon fiber, aluminum, carbon steel, plastics, ceramics, stainless steel, or the like. These materials provide strength and durability to the assembly, ensuring that it can support the weight of the solar panels and withstand the elements. The top member 12 and the bottom member 30 can be adjusted to any size solar panel 60, as shown in FIG. 6, thickness 62 and can allow the user to remove single sections of the water diversion device 10 that are attached to the solar panel. The second top vertical member 20 and the second bottom vertical member 38 can have a protected coating or covering on it to protect the solar panel 60.

The compression member 40 can be such as, for example, foam, rubber, silicone, buna-n, cork, or the like. The compression member 40 can be formed by such as, for example, extrusion, mold, latex dipping, calendaring or the like. The compression member 40 can be any suitable shape but in the preferred embodiment the compression member can be such as, for example, circular, oval, rectangular, triangular, or the like, or as shown in FIG. 2.

The first channel 24 and the second channel 44 can collect and direct water down the channels to a central location on the structure thus keeping the water off the ground and vehicles below. The solar panel 60 can be connected by such as, for example, wire, fasteners, fittings, or any combination thereof, to the water diversion and grounding device grounding the solar panel to the structure. The solar panel is grounded to the assembly. This grounding provides a safe and effective way to prevent electrical shocks and other electrical hazards.

In conclusion, the present invention provides a water diversion and grounding system 10 for supporting a plurality of solar panels 60. The system 10 comprises an assembly having a length and including a top member 12, a bottom member 30, and a compression member 40. The assembly 10 is designed to provide a secure and stable support for the solar panels while also facilitating the diversion of water and grounding of the solar panels. The assembly also includes at least one fastener securing the top member and the bottom member to the compression member. The fastener 42 is designed to provide a secure and stable connection between the top member 12, the bottom member 30, and the compression member 40. The assembly 10 also includes a plurality of holes 22 for the insertion of the fasteners 42. The solar panel 60 is grounded to the assembly, providing a safe and effective way to prevent electrical shocks and other electrical hazards.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. A water diversion and grounding system for supporting a plurality of solar panels, the system comprising:
an assembly having a length and comprising a top member, a bottom member, and a compression member;
wherein the compression member has a compression top having a compression top width and a compression bottom having a compression bottom width;
wherein the top member comprises a top base with a top base width, a first top vertical extension extending a first height from the top base, and a first top horizontal member extending from the first top vertical extension;
wherein the bottom member comprises a support with a first bottom vertical extension extending a second height from the support and a first bottom horizontal member extending a first distance from the bottom vertical extension and a first peripheral vertical member extending in the direction of the support from the bottom horizontal member; and
at least one fastener securing the top member and the bottom member to the compression member.

2. The water diversion and grounding system according to claim 1, wherein the top member has at least one second top vertical member extending from the first top horizontal member.

3. The water diversion and grounding system according to claim 1, wherein the top member further comprises a second top vertical extension extending the first height from the top base to define a channel, and a second top horizontal member extending from the second top vertical extension.

4. The water diversion and grounding system according to claim 1, wherein the bottom member further comprises a second bottom vertical extension extending the second height from the support and a second bottom horizontal member extending the first distance from the second bottom vertical extension and a first peripheral vertical member extending in the direction of the support from the bottom horizontal member to define an inverted channel.

5. The water diversion and grounding system according to claim 1, wherein the base, the support, and the compression member has a plurality of holes extending from one end to the other wherein the holes align with each other allowing the plurality of fasteners to be inserted into the base, support and compression member.

6. The water diversion and grounding system according to claim 5, wherein the base and the support compresses the compression member and clamps the solar panel between the base and the support when the plurality of fasteners is tightened.

7. The water diversion and grounding system according to claim 1, wherein the top member and bottom member are aluminum or carbon steel.

8. The water diversion and grounding system according to claim 1, wherein compression member is a rubber material.

9. The water diversion and grounding system according to claim 1, wherein the length of the top member, bottom member and compression member are the same length to define the length of the assembly.

10. The water diversion and grounding system according to claim 9, wherein the length is about 36 inches.

11. The water diversion and grounding system according to claim 9, wherein the solar panel is grounded to the assembly.
